(19) United States
(12) Patent Application Publication
(10) Pub. No.: US 2008/0206557 A1
(43) Pub. Date: Aug. 28, 2008

(54) Thermoplastic Welding Rod

(75) Inventors: Jorg Nienaber, Hude (DE); Guido Burmeister, Wildeshausen (DE); Edwin Lorke, Delmenhorst (DE)

Correspondence Address: SUGHRUE MION, PLLC, 2100 PENNSYLVANIA AVENUE, N.W., SUITE 800, WASHINGTON, DC, 20037, US

(73) Assignee: Armstrong DLW AG, Bietigheim-Bissingen (DE)

(21) Appl. No.: 11/996,155

(22) PCT Filed: Jul. 17, 2006
(86) PCT No.: PCT/EP06/07026

§ 371 Date: Mar. 11, 2008

(30) Foreign Application Priority Data
Jul. 22, 2005 (DE) 10 2005 034 361.9

(51) Int. Cl. B32B 27/08; C08L 31/04

(52) U.S. Cl. 428/335; 524/563; 524/277; 524/77; 428/395; 428/332

(57) ABSTRACT

A thermoplastic welding wire for bonding and/or welding flexible planar formations such as floor or wall coverings, in particular linoleum floor or wall coverings, is provided, which comprises at least one polymer based on an ethylene-vinyl acetate copolymer and at least one wax. The welding wire may possibly have shellac or a sheath based on at least one hot-melt adhesive. The welding wire has a high melt-flow index and has a very low soiling tendency.

The present invention relates to a thermoplastic welding wire and/or a thermoplastic welding cord for welding flexible planar formations such as floor or wall coverings, in particular for welding floor or wall coverings based on linoleum.

Thermoplastic welding wires have been known per se for some time and are used to a large extent for welding floor and wall covering webs. Typical welding wires, such as welding wires for linoleum floor coverings, comprise a base polymer, paraffin waxes for providing desired mechanical properties, such as hardness and scratch resistance, and resins for providing the required stickiness. Because of their stickiness, after the introduction into the glued joint between the webs to be bonded of linoleum floor coverings, for example, the resins ensure a sufficient flank adhesion, i.e., adhesion of the welding wire material to the cut edges and/or flanks of the webs to be bonded to one another. The stickiness of the welding wire and thus also of the adhesive bond to be produced with its aid, i.e., the weld seam, however, results in the disadvantage that the welding wire surface and thus also the surface of the weld seam displays a high soiling tendency. This soiling tendency of the weld seam results in a visual impairment of the floor covering after a short time, which requires cleaning of the floor covering and in particular the weld seam at very short time intervals. Often, the soil in the glued joint may not be completely removed or may only be removed with significant effort.

It is therefore an object of the present invention to provide a thermoplastic welding wire, which does not have the disadvantages of the prior art, i.e., in particular displays a significantly reduced soiling tendency and which nonetheless maintains the good properties of typical welding wires in regard to a reliable and tight bond of the flexible coverings to be bonded and simple handling.

This object is achieved by the welding wire defined in Claim 1. Advantageous refinements of the welding wire according to the present invention are explained in greater detail in the subclaims.

The thermoplastic welding wire according to the present invention for welding flexible planar formations such as floor or wall coverings of all types, in particular linoleum floor or wall coverings, comprises at least one polymer based on an ethylene-vinyl acetate (EVA) copolymer and at least one wax, preferably a natural wax. The thermoplastic welding wire according to the present invention dispenses with the tackifying resins typically used for ensuring sufficient stickiness and instead uses at least one polymer based on an ethylene-vinyl acetate copolymer, which is actually a base polymer. However, it is to be ensured according to the present invention that the polymer(s) based on an ethylene-vinyl acetate copolymer has/have a specific, high melt-flow index, as specified in the following, and also that the resulting thermoplastic welding wire additionally has a specific, high melt-flow index, as also specified in the following.

In addition, the thermoplastic welding wire according to the present invention has a very high proportion of 25 wt.-% to 60 wt.-% of the at least one wax, in relation to the total amount of the at least one polymer based on an ethylene-vinyl acetate copolymer and the at least one wax.

The soiling tendency of the weld seam is significantly reduced by the above-mentioned measures, the welding wire according to the present invention nonetheless ensuring a permanent and tight welded bond. In further designs, the welding wire according to the present invention has shellac or a sheath made of at least one hot-melt adhesive.

More precisely, the thermoplastic welding wire according to the present invention comprises at least one polymer based on an EVA copolymer having a very high melt-flow index and at least one natural wax for providing hardness and scratch resistance to the produced weld seam. The possibly provided shellac or possibly provided sheath made of at least one hot-melt adhesive, preferably based on polyamide, is used to improve the cohesion of the weld seam and its flank adhesion, i.e., the adhesion at the edges of the covering webs to be bonded.

In many cases, a welding wire according to the present invention, which comprises at least one polymer based on an EVA copolymer and at least one wax as constituent components, is sufficient to ensure a permanent and tight weld seam. Flexible planar formations, e.g., floor coverings based on synthetic materials such as polyvinyl chloride (PVC), ethylene vinyl acetate (EVA), alkyl acrylate, and the like may thus be welded with high quality using this welding wire.

If the flank adhesion of the welding wire, which only comprises at least one polymer based on an EVA copolymer and at least one wax as constituent components, is not sufficiently high at the edges and/or flanks of the webs to be bonded, the welding wire according to the present invention may have the following special embodiments.

a) The welding wire formula, which comprises at least one polymer based on an EVA copolymer and at least one wax as constituent components, is admixed with shellac, which has an adhesion-promoting effect in the molten state, the adhesion improvement also being maintained after the cooling and thus solidification of the welding wire, without the polarity and the soiling behavior of the weld seam surface being changed. b) The welding wire is provided with a sheath made of at least one hot-melt adhesive, the at least one hot-melt adhesive also having a very high melt-flow index. This is particularly advantageous for flexible planar formations made of a more or less porous material, in particular for coverings based on linoleum. Because of the high melt-flow index of the EVA copolymer(s) used in the welding wire according to the present invention and the low viscosity of the melt resulting therefrom, this melt penetrates very easily into the pores and cavities in the cut edges (flanks) of the webs to be bonded. The penetrated welding wire material is fixed in the pores and cavities after cooling, however, the cohesion of the welding wire, which contains a significant proportion of wax in addition to the EVA copolymer(s), may not be sufficient to ensure the required flank adhesion of the welding wire on the porous and thus rough surface of the edges of the covering webs to be bonded, which does not form a regular and smooth contact surface.

In this case, adding shellac as a cohesion-reinforcing adhesion promoter to the welding wire results in an increase of the flank adhesion, because, in the molten state, the shellac results in improved adhesion of the molten welding wire compound at the flanks of the webs to be bonded, this improved adhesion also being maintained after the cooling of the weld seam, without resulting in increased soiling tendency of the weld seam because of the addition of shellac. Hydrocarbon resins used in typical welding wires to increase the stickiness do not have behavior of this type.

If the desired adhesion at the flanks of the webs to be bonded is not achieved, the thermoplastic welding wire according to the present invention may be provided with a sheath made of at least one hot-melt adhesive alternatively to the addition of shellac to the welding wire formula. This sheath results in a significant improvement of the flank adhesion, because upon melting of the welding wire introduced into the web joint, essentially only the hot-melt adhesive penetrates into the pores of the flanks of the covering webs and thus forms a relatively smooth surface (contact surface) anchored in the pores and cavities after cooling, which produces a very stable planar adhesive bond to the welding wire core. The improvement of the flank adhesion is probably also to be attributed to the wax-free hot-melt adhesive of the sheath having a higher cohesion than the welding wire core.

The sheath made of at least one hot-melt adhesive which is possibly provided on the welding wire according to the present invention is implemented in a very thin layer. The thickness of the sheath is in the range from 0.05 mm to 0.3 mm, preferably in the range from 0.1 mm to 0.2 mm.

The thermoplastic welding wire according to the present invention may be processed in a typical way, for example, in such a way that the welding wire is introduced into the joint to be formed between the webs to be bonded and is brought into the free-flowing state by heating, for example, using a hot-air device. The liquid and/or free-flowing welding wire then completely fills up the joint of the covering webs. After cooling, the projecting part of the welding wire is removed plane-parallel to the surface of the bonded covering webs in a typical way, e.g., with the aid of a knife.

In the embodiment of the welding wire according to the present invention which has a hot-melt adhesive sheath, the presence of a hot-melt adhesive in the weld seam does not result in significant worsening of the soiling behavior because of the low layer thickness of the hot-melt adhesive sheath. If the protruding part of the weld seam remaining after the introduction of the welding wire into the web joint and after its melting and subsequent cooling is removed in the way described above using a knife, for example, only extremely narrow and practically invisible areas made of hot-melt adhesive result on the surface of the weld seam along the edges of the covering webs to be bonded in the transition to the surface of the weld seam, the weld seam being almost completely formed from the welding wire core, which is insensitive to soiling.

Because all of the above-mentioned polymer components of the welding wire according to the present invention have a very low melt viscosity (i.e., a very high melt-flow index), and the at least one wax used naturally results in an extremely low-viscosity melt, the molten welding wire is capable of penetrating and/or flowing into the micropores of the covering webs, in particular in the case of linoleum covering webs. As soon as the molten material of the welding wire has solidified by cooling, it ensures a bond of the covering webs having very high flank adhesion and simultaneously outstanding tightness of the glued joint. In embodiments of the welding wire according to the present invention sheathed with hot-melt adhesive, this is also ensured for porous web materials such as linoleum in particular in any case. It has been shown in the scope of the present invention that because of the fact that the welding wire according to the present invention does not contain any adhesive components in the usual meaning, the soiling tendency of the welding wire and thus also of the weld seam resulting therefrom is significantly reduced and/or no longer or only insignificantly differs from the soiling tendency of the covering webs themselves, without quality losses of the seam bond. In many cases, it is even possible to reduce the soiling tendency of the weld seam in comparison to the covering webs to be bonded.

In the field of floor and wall coverings, in particular floor coverings, the covering is typically provided with a so-called finish. A finish is a coating which represents a protective layer for the floor covering and improves its usage properties, e.g., prevents and/or reduces premature wear of the useful layer of the floor covering. Frequently used finishes are produced on the basis of polyurethane (PUR) or acrylate homopolymers or their copolymers with one another. These finishes may be removed again relatively easily during the cleaning and care of the floor covering and renewed if desired.

Floor coverings, even linoleum floor coverings, are increasingly provided with an above-mentioned finish which may be cross-linked using UV radiation, for example, and then forms an extremely resistant and long-wearing protective layer, but which may only still be removed again by significant mechanical effort. Problems frequently arise in regard to increased soiling tendency of the weld seam when floor coverings having a finish of this type made of cross-linked PUR, for example, are welded using a typical welding wire, because no protective layer due to otherwise typical care is present on the weld seam. It has also been shown in the scope of the present invention that the welding wire according to the present invention, in particular the welding wire provided with a hot-melt adhesive sheath, is outstandingly suitable for welding webs made of so-called PUR linoleum, i.e., linoleum which is coated using a finish made of cross-linked PUR. The welding wire according to the present invention may generally be used for welding flexible floor and wall coverings made of greatly varying materials, including those of natural and synthetic origin.

The EVA copolymer used in the welding wire according to the present invention is not particularly restricted in its type and composition in regard to the proportion and the configuration of the monomers in the molecular chain. However, EVA copolymers which have a vinyl acetate content of 15 wt.-% to 35 wt.-%, and correspondingly an ethylene content of 85 wt.-% to 65 wt.-%, in relation to the total weight of the EVA copolymer, are preferred. According to the present invention, a single EVA copolymer may be used, or also a mixture of two or more EVA copolymers.

As noted above, it is decisive for the suitability of the EVA copolymer that it has a very high melt-flow index. The melt-flow index is in the range from 100 g/10 minutes to 830 g/10 minutes, preferably from 350 g/10 minutes to 550 g/10 minutes in the scope of the present invention, measured according to ASTM 1238 at a temperature of 125° C. and a load of 325 g.

Any wax fundamentally comes into consideration as the wax for the welding wire according to the present invention, i.e., any natural vegetable wax, animal wax, or mineral wax, but also chemically altered waxes and synthetic waxes, if it provides the welding wire and in particular the weld seam produced therefrom with sufficient hardness and scratch resistance. Waxes are characterized, inter alia, in that they are generally solid to brittle hard at room temperature, but represent low-viscosity liquids solely because of their melting point. Natural waxes are preferred, not least for reasons of availability and renewability as renewable raw materials, but also from environmental aspects. Candelilla wax, Japan wax, carnauba wax, beeswax, montan wax, shellac wax, lanolin, ceresin, ozokerite, petrolatum, paraffin waxes, and microcrystalline waxes are cited as examples of natural waxes of this type. Carnauba wax, beeswax, and shellac wax are preferred and carnauba wax is especially preferred.

If shellac is added to the welding wire according to the present invention, a non-dewaxed type may be used, which naturally also introduces a component of natural wax.

The hot-melt adhesive used in the welding wire according to the present invention is not fundamentally subject to any special restriction and typical hot-melt adhesives such as hot-melt adhesives based on EVA, polyisobutylene (PIB), polyvinyl butyral (PVB), and polyamide (PA) may be used, if their melt-flow index has a value of at least 200 g/10 minutes and not more than 400 g/10 minutes. The melt-flow index is preferably at most 350 g/10 minutes and more preferably at most 300 g/10 minutes, measured according to ASTM 1238 at a temperature of 125° C. and a load of 325 g.

Among the hot-melt adhesives, those based on PA are especially preferred, because they result in a very high flank adhesion, display low soiling tendency in comparison to other hot-melt adhesives after cooling, and provide the weld seam with good hardness and scratch resistance.

The components EVA copolymer and wax are present in specific quantity ratios in the welding wire according to the present invention. The at least one EVA copolymer is provided in a quantity of 40 wt.-% to 75 wt.-%, preferably 55 wt.-% to 65 wt.-%, in relation to the total quantity of EVA copolymer and wax.

The shellac used in one embodiment of the welding wire according to the present invention as an adhesion promoter displays partial polymerization and/or cross-linking upon processing of the welding wire at typical processing temperatures, which improves the product properties of the resulting welding wire because of the additional hardening of the surface of the weld seam and a further reduction of the soiling tendency accompanying it.

The shellac may be added to the thermoplastic welding wire according to the present invention in a quantity of 5 wt.-% to 15 wt.-%, preferably approximately 10 wt.-%, in relation to the total quantity of the at least one polymer based on EVA copolymer and the at least one wax.

As noted, all of the constituent components of the welding wire according to the present invention (i.e., the EVA copolymer(s) and possibly the hot-melt adhesive(s)) have a very high melt-flow index, the wax(es) used naturally also having a very low melt viscosity, and correspondingly the welding wire produced therefrom having a high melt-flow index overall, which is in the range from 2 g/10 minutes to 150 g/10 minutes, preferably in the range from 4 g/10 minutes to 70 g/10 minutes, measured according to ASTM 1238 at a temperature of 80° C. and a load of 15 kg. Maintaining the melt-flow index of the welding wire is of great significance, because otherwise the favorable properties of the welding wire may be impaired.

The welding wire according to the present invention may have further ingredients in addition to the above-mentioned constituent components, such as typical processing aids, UV stabilizers, antioxidants, fillers, pigments, colorants, etc., as long as the required properties in regard to melt and flow behavior, adhesion, cohesion, and low soiling tendency are not impaired.

In particular, the welding wire may be colored to be visually tailored to the color of the covering webs to be bonded. The welding wire may be implemented as monochrome by adding colorant(s) and/or pigment(s), however, it may also be multicolored and have any desired pattern, depending on how it is to fit the colored and/or patterned covering. The coloring of the welding wire may be performed in a way known per se and is not subject to any special restriction. For example, one or more colorants and/or pigments may be added to the starting mixture of the components for the welding wire and this mixture may then be brought into the shape of the desired welding wire in a typical way, e.g., by melting and extruding. If the welding wire is to be patterned multicolored, for example, different colored granules may be produced from the components for the welding wire and subsequently a mixture made of at least two differently colored granules may be brought into the shape of the desired welding wire. In addition, any other type of patterning may also be applied. If the welding wire has a hot-melt adhesive sheath, this sheath is preferably either transparent or, as described above, colored or patterned in one or more colors.

The welding wire may have any external shape, but preferably has a circular or oval cross-section. The diameter of a welding wire having a circular cross-section is generally approximately 2 to approximately 6 mm, preferably approximately 3 to approximately 5 mm, and more preferably approximately 4 mm.

If the welding wire according to the present invention has a hot-melt adhesive sheath, the above-mentioned ranges for the diameter of the welding wire include the layer thickness of the sheath.

A thermoplastic welding wire for bonding and/or welding flexible planar formations, in particular floor and wall coverings, is provided by the present invention, which is capable of reliably, permanently, and tightly bonding the covering webs in a simple way, and which results in a weld seam which has a significantly lower soiling tendency than typical welding wires. The welding wire according to the present invention is also outstandingly suitable above all for welding linoleum floor and wall coverings. This may also be a linoleum floor or wall covering which has a finish, for example, a finish based on acrylate or polyurethane, including so-called irreversible, i.e., cross-linked PUR finishes.

Because of the reduced soiling tendency of the welding wire and the weld seam resulting therefrom, a significant quality improvement of the floor or wall covering is to be noted, because the amount of required cleaning work of the covering is reduced, i.e., the time intervals between the cleaning and possibly polishing work are significantly lengthened.

Furthermore, the welding wire according to the present invention has a higher proportion of natural starting materials and is thus, in particular when used for welding linoleum floor coverings, in greater correspondence with environmental consciousness, which is always becoming stronger.

The present invention is explained in greater detail by the following example, which is in no way restrictive. Percentages relate to the weight, if not otherwise specified.

### EXAMPLE

A welding wire according to the present invention was produced from the components specified in the following table in the quantities also specified.

| | | Concentration (wt.-%) in | | |
|---|---|---|---|---|
| | | relation to the total mix- | | |
| Number | Component | ture after adding pigment | Producer | Notes |
| 1 | Carnauba wax | 33.9 | Kahl & Co | |
| | | | Vertriebs- | |
| | | | ges.mbH, Trittau | |
| 2 | Escorene ® (EVA copolymer | 62.9 | Exxon Mobil | |
| | having a vinyl acetate | | Chemical | |
| | content of 19 wt.-%) | | Company | |
| 3 | Markscreen ® (oligomeric, | 0.2 | Crompton Vinyl | Thermal |
| | sterically blocked phenol) | | Additives GmbH | antioxidant |
| 4 | Pigment mixture of | 3.0 | Various | |
| | inorganic and/or organic | | | |
| | pigments | | | |

### Production Method

The formula components 1+2 were melted and fed to the intake of a commercially available dual-shaft extruder. The pigment/antioxidant mixture was introduced immediately afterward into the extruder via an automatic dosing feed and incorporated homogeneously into the melt.

The entire method part remained unheated and the head temperature of the extruder was set to 85° C.

The resulting round strand having a diameter of 4 mm passed through a water bath for complete solidification and was then coiled up.

### Processing

A sufficient quantity of the material was introduced into a milled-out floor covering joint as follows:
1. Introducing the welding wire into the floor covering joint using a hot-air hand welding device and attached welding nozzle having a diameter of 4 mm at 350-400° C.;
2. Chipping off the excess material shortly above the floor covering surface with the aid of a commercially available cutter slide; and
3. Plane-parallel chipping off of the weld seam.

### Experimental Results

The soiling tendency of the welding wire according to the present invention in comparison to a typical welding wire was assayed as follows:

The assay was performed based on DIN EN 660-1, testing soil according to DIN EN 1269 being used. A square test subject having an edge length of 190 mm was produced from the material of the welding wire and this was stuck onto a light metal plate using double-sided adhesive tape. This test subject was referred to as a standard sample and was used for comparison to a sample soiled in the following soiling test.

For the soiling test, a further test subject was stored for at least 24 hours in standard climate according to DIN 50014-23/50-2.

The test to determine the soiling tendency is performed as follows:
3 g of the above-mentioned test soil is applied to the test subject;
the load pendulum is lowered;
50 double-step strokes are executed;
the test subject is unclamped and the test soil is removed using vacuum cleaner and brush;
half of the test subject is cleaned using water and abrasive cleaner;
the soiling is evaluated.

To evaluate the soiling, which is expressed in a color change, this color change is evaluated with the aid of the gray scale according to DIN EN 20105-A02, the side of the soiled test subject cleaned on one half using water and abrasive cleaner being compared to the (unsoiled) standard sample. The evaluation is performed in five stages, stage 1 indicating the strongest color change (soiling) and stage 5 indicating no color change.

The test subject produced from the material of the welding wire according to the present invention was evaluated as stage 3 in the soiling test described above. A test subject produced from the material of a typical welding wire for elastic floor coverings was evaluated as stage 2, in contrast, which means that this test subject displayed a significantly higher tendency toward soiling than a test subject produced from the material for a welding wire according to the present invention.

1. A thermoplastic welding wire for welding flexible planar formations, comprising at least one polymer based on an ethylene-vinyl acetate copolymer and at least one wax, wherein the at least one polymer based on an ethylene-vinyl acetate copolymer is provided in the welding wire in a quantity of 40 wt.-% to 75 wt.-%, in relation to the total quantity of the at least one polymer based on an ethylene-vinyl acetate copolymer and the at least one wax, and the welding wire has a melt-flow index of 2 g/10 minutes to 150 g/10 minutes (measured according to ASTM 1238 at a temperature of 80° C. and a load of 15 kg).

2. The welding wire according to claim 1, wherein the at least one polymer based on an ethylene-vinyl acetate copolymer has a melt-flow index of 100 g/10 minutes to 830 g/10 minutes (measured according to ASTM 1238 at a temperature of 125° C. and a load of 325 g).

3. The welding wire according to claim 1, wherein the at least one polymer based on an ethylene-vinyl acetate copolymer has a vinyl acetate content of 15 wt.-% to 35 wt.-%, in relation to the weight of the ethylene vinyl acetate copolymer.

4. The welding wire according to claim 2, wherein the at least one wax is a natural wax, selected from vegetable waxes, animal waxes, and mineral waxes, and arbitrary mixtures thereof.

5. The welding wire according to claim 4, wherein the at least one natural wax is selected from Candelilla wax, Japan wax, carnauba wax, montan wax, and arbitrary mixtures thereof.

6. The welding wire according to claim 1, wherein the welding wire additionally has shellac.

7. The welding wire according to claim 6, wherein the shellac is provided in the welding wire in a quantity of 5 wt.-% to 15 wt.-%, in relation to the total quantity of the at least one polymer based on an ethylene-vinyl acetate copolymer and the at least one wax.

8. The welding wire according to claim 1, wherein the welding wire has a sheath based on at least one hot-melt adhesive.

9. The welding wire according to claim 8, wherein the hot-melt adhesive is a hot-melt adhesive based on polyamide.

10. The welding wire according to claim 8, wherein the at least one hot-melt adhesive has a melt-flow index of at least 200 g/10 minutes and not greater than 400 g/10 minutes (measured according to ASTM 1238 at a temperature of 125° C. and a load of 325 g).

11. The welding wire according to claim 8, wherein the sheath based on at least one hot-melt adhesive has a thickness of 0.05 mm to 0.3 mm.

12. The welding wire according to claim 1, wherein the welding wire, with a circular cross-section, has a diameter, including a possibly provided sheath based on at least one hot-melt adhesive, of 2 mm to 6 mm.

13. The welding wire according to claim 1, wherein the welding wire is colored.

14. A use of a welding wire according to claim 1 for welding flexible planar formations.

15. The use according to claim 14, wherein the flexible planar formations are floor or wall coverings.

16. The use according to claim 15, wherein the floor and wall coverings are linoleum floor or wall coverings.

17. The use according to claim 16, wherein the linoleum floor or wall coverings have a finish.

18. The use according to claim 17, wherein the finish is produced on the basis of non-cross-linked or cross-linked polyurethane or acrylate homopolymers and their copolymers with one another.
